(19) United States
(12) Patent Application Publication
(10) Pub. No.: US 2003/0159932 A1
(43) Pub. Date: Aug. 28, 2003

(54) Method and apparatus for analysing low concentrations of particles

(76) Inventors: Walter Bernard Betts, Yorkshire (GB); Andrew Paul Brown, Yorkshire (GB)

Correspondence Address: CHRISTIE, PARKER & HALE, LLP, 350 WEST COLORADO BOULEVARD, SUITE 500, PASADENA, CA, 91105, US

(21) Appl. No.: 10/275,410

(22) PCT Filed: May 3, 2001
(86) PCT No.: PCT/GB01/01940

(30) Foreign Application Priority Data
May 3, 2000 (GB) 0010518.9

(51) Int. Cl. G01N 27/26

(52) U.S. Cl. 204/547; 204/643

(57) ABSTRACT

A method and apparatus for analysing very low concentrations of particles present in a fluid sample. The apparatus comprises a support (1) defining and fluid flow channel (9) and a dual electrode array comprising a first electrode means (2) and a second electrode means (3). The first electrode means (2) is energised with an AC voltage of predetermined frequency to attract a predetermined type of particle to the electrode. The voltage is then switched off after a period of time and the second electrode means (3) is energised with an AC voltage of predetermined frequency. After a period of time the voltage is switched off, releasing the particles from the second electrode means for subsequent collection and/or enumeration.

The present invention relates to a method and apparatus for collecting and analysing low concentrations of abiotic and/or biotic particles, such as biological cells, cell organelles, viruses and prions, and chemicals, biochemicals or macromolecules using dielectrophoresis. It also relates to methods and apparatus for enumerating and identifying a particular particle present in a test sample.

It is well known that when an AC voltage is applied to a pair of electrodes which have a suspension of particles between them, the particles may polarise and have a force exerted upon them where the electric field is non-uniform (see for example Pohl, 1978). This translational force (the dielectrophoretic force) may cause the particles to aggregate in areas of either high or low electric field gradient, dependant upon the relative polarisabilities of the particles and the suspending medium. The polarisabilities of the particle and medium are functions of their conductivity and permittivity, and vary with the frequency of the electric field (Pethig, 1991; Pethig et al., 1992; Betts, 1995). With increasing frequency successive mechanisms will drop out of the polarisation process as their relaxation can no longer keep pace with the speed of the alternating field. Thus when using AC electric fields, the level of particle collection at electrodes observed over a frequency range will vary. Measuring the number of particles collected as the frequency of the voltage generating the electric field changes allows a collection spectrum to be plotted as described by WO 91/08284. These spectra been shown to be characteristic for individual species of biological cells and for abiotic particles, since the polarisability of a particle type is dependant upon its individual, unique structure.

This AC electrokinetic technique, known as dielectrophoresis (DEP), has been shown to be useful for particle and cell characterisation and also for the separation of a particle type from a mixed suspension (Hagedorn et al., 1992; Huang et al., 1993; Gascoyne et al., 1992; Gascoyne et al., 1994; Huang et al., 1992) and also for the manipulation of biomolecules (Washizu & Kurosawa, 1990; Cheng et at., 1998). Cells or particles become polarised by the action of AC electric fields and will experience a dielectrophoretic force when these fields are non-uniform. The dielectrophoretic force is a function of frequency, determined by the electrical properties of the cell, reflecting cell structure and morphology. Therefore cells with different electrical properties and polarisability will experience differential dielectrophoretic action, allowing separation of different cell types. By utilising selective differences in DEP response, the separation of live and dead yeast cells (Pohl & Hawk, 1966; Crane & Pohl, 1968; Pohl & Crane, 1971), cancerous and normal cells (Burt et al., 1990; Becker et al., 1994), and bacterial species (Markx et al., 1994; Markx et al., 1996) have all been achieved. Analyses of other micro-organisms, such as the water-borne protozoan Cryptosporidium parvum, have also shown that the determination and separation of different viability states is possible using dielectrophoretic methods (Archer et al. 1993; Quinn et al., 1995; Archer et al., 1995; Quinn et al., 1996; Goater et al., 1997).

Many DEP methods of cell separation have relied upon the application of a single, fixed-frequency, AC voltage to an electrode structure. In particular, the frequency of the electric field and the dielectric constant and electrical conductivity of the suspending medium is selected to produce positive and negative dielectrophoretic forces, where the positive dielectrophoretic force acts upon some only of the particles in the suspension (to attract particles to electrode surfaces where the field gradient is high), and the negative dielectrophoretic force acts upon a different population of particles in the suspension (repelling these particles to a spatially separate region of low, normally zero, electric field gradient) (Pethig et al., 1992). Markx et al. (1994) also used castellated electrodes to bring about a localised separation of Saccharomyces cerevisiae and Micrococcus lysodeikticus by this method. Use of conductivity gradients or suspending media to facilitate dielectrophoretic separation has also been shown (Markx et al., 1996). Since negative DEP repels particles to energy minima, a constant flow of the suspension can remove those particles undergoing negative DEP, whereas those undergoing positive DEP will remain in the areas of high field gradient and be separated from the suspension.

Whilst dielectrophoretic methods have been shown to be particularly effective for enabling cell and particle separations, a problem for many potential applications for dielectrophoresis is the requirement to detect and analyse very low concentrations of particles (including biological cells, cell organelles, viruses, prions, macromolecules and abiotic particles). The following examples illustrate the problem: regulations stipulate that coliform bacteria should not be present in 100 ml potable water and thus the organism should be detectable at the level of 1 coliform per 100 ml (Anon., 1989), hygienically significant concentrations of bacteria within food samples are commonly <10⁴-10⁵ cfu/g and it is accepted that detection of 1 bacterium in 25 g of food is necessary for some important microorganisms (International Commission on Microbiological Specifications for Foods); the presence of bacteria in certain contaminated blood products need to be detectable at the clinically significant level of 10⁵ cfu/ml (Muder et al., 1992; Leiby et al, 1997); and oocysts of the protozoan Cryptosporidium should be detectable at the level of one oocyst in 10 litres of water based on continuously sampling 1000 litres of treated water per day (Anon., 1989).

Traditional microbiological methods almost exclusively require enrichment techniques involving incubations of several hours to several days allowing the proliferation of cells to detectable levels. Dielectrophoretic techniques offer an alternative procedure, which do not necessitate long incubations or enrichment stages. Instead, native organisms present within the sample can be analysed after abstraction from the sample matrix.

Though dielectrophoretic analysis of single cells has been described previously using several systems (including feedback-controlled levitation and measurement of dielectrophoretic forces necessary to hold a cell against the force of gravity) (Crane & Pohl, 1977; Kaler & Jones, 1990; Fuhr et al., 1998; Fuhr & Reichle, 2000; Schnelle et al., 2000), dielectrophoretic techniques have suffered from difficulties in analysing larger sample volumes of low cell concentration.

This difficulty is, in part, related to the nature of the available detection systems used to quantify the number of particles collected upon the electrodes (or elsewhere). For example, spectrophotometric detection required levels of 10⁷-10⁸ cfu/ml to give high signal:noise ratio; image analysed microscopical detection similarly requires particle concentration in excess of 10⁶ cfu/ml (Brown et al., 1999). This limitation is also due to the nature of the dielectrophoretic electrodes and their containment chambers, which provide poor collection efficiencies, especially when utilising a twin parallel bar electrode arrangement with a relatively small edge surface area (as described by WO 91/08284). Due to: i) relatively deep channels in the chamber; ii) small detection area “windows”; iii) small electrode edge length, and iv) the use of slow collection speeds and short pulse lengths (to reduce the analysis time), as few as 100-200 cells might be detected out of a circulating concentration of 10⁶ cfu/ml.

Larger surface area, multiple electrode array configurations are more efficient at particle collection due to the increased total electrode edge length available for cell collection, allowing more rapid and efficient collection of particles from larger sample volumes. For example, multiple interdigitating electrode arrays can be produced which have 200 electrode bars or greater, each of 1 cm length×100 μm width with a 10 μm inter-electrode gap, enabling a significant increase in collection efficiency. However, such arrays are disadvantageous for detection when standard techniques such as image analysis microscopy are used due to the small field of view. Techniques are available which enable the scanning or detection of a complete electrode array. However electrical detection e.g. impedance (as described in copending patent application 0001374.8) of dielectrophoretic collection upon these large surface area arrays is made difficult due to the large electrode length which leads to low sensitivity. Similarly, collection of cells on top of each other, or cells being obscured by the electrode metal can make such methods inefficient. Counting of cell collection is often performed downstream of electrodes to avoid such issues as described in WO 91/08284. However, since these arrays are large, there may be a significant time delay before cells released from the large electrode arrays pass through the detection window, and the peak of detection is often indistinct. If there are very low concentrations of cells, then individual cells might be collected on electrodes at large distances from each other and the electrode “window” imaged might not contain any cells at all. Furthermore, over this period, the released particles have time to move out of the plane of focus of the microscope and may not be detected. This means that even though low concentrations of particles may be collected using dielectrophoresis, they cannot currently be detected accurately using techniques such as spectrophotometry, image analysis microscopy and others.

It is an object of the invention to provide an accurate dielectrophoretic method and apparatus for rapidly enumerating particular particles present in a test sample at low concentrations.

It has now been found that by utilising a novel dual electrode arrangement comprising a first electrode means and a second electrode means, passing or circulating a liquid sample containing a low concentration of particles suspended therein past the electrode arrangement, applying at least one AC voltage of predetermined frequency to the first electrode means, switching off the voltage(s) to the first electrode means and applying the same or a different AC voltage(s) to the second electrode means, then switching off the voltage(s) to the second electrode means, that it is possible to collect and/or analyse very low concentrations of abiotic and/or biotic particle or biomolecules.

WO 91/11262 disclosed the application of electrical fields of different characteristics to several separate arrays of electrodes, energised independently, for the purposes of spatially separating particle and cell types from a mixture on the basis of dielectrophoretic properties. GB 2,266,153 described a column array of interdigitating electrodes which could be energised to selectively retard cell populations within a mixture for subsequent elution of separated components, acting as a dielectrophoretic chromatographic column. A similar invention described by Markx et al. (1997) is that of field flow fractionation (FFF), whereby dielectrophoretic levitation of particles is used to displace particles into different regions of a parabolic flow profile travelling at different velocities.

Unlike the inventions described above, the use of multiple interdigitating electrode arrays described in the present invention is not designed solely for fractionation or separation of particle or cell types, but rather to act as a large area electrode unit for general improved collection efficiency and abstraction of large numbers of cell from suspensions of low concentration. Such electrode arrays described here have been shown to abstract an average of 40-50% of cells from the suspension passing the electrodes when tested with Escherichia coli or Staphylococcus epidermidis bacterial species. Further, the use of the fluid velocity flow profile to cause a slow flow of particles released from the first electrode array is not used for separation as in FFF, but to increase the efficiency of recollecting the particles upon the second “focusing” electrode array.

According to one aspect of the invention there is provided a method of analysing very low concentrations of particles present in a fluid sample, the method comprising passing or circulating the liquid or gaseous sample through a region of non-uniform electric field density produced by a dual electrode arrangement, said arrangement comprising a first electrode means for producing successive electric fields so as to collect all or most of the particles in the sample and a second electrode means to collect all the particles released from the first electrode means for detection, energising said first electrode means with at least one AC voltage having a predetermined frequency selected to attract a predetermined type of particle in the sample to said array, switching off the voltage(s) to the first electrode means thereby releasing the particles, energising the second electrode means with at least one AC voltage having a predetermined frequency selected to attract particles in the sample to said second electrode means, switching off the voltage(s) to the second electrode means thereby releasing the particles for subsequent separation, collection, identification and/or enumeration.

The first electrode means of the dual electrode arrangement comprises an electrode with a large surface area to provide for particle collection. Thus, it may comprise a multiple electrode array such as a multiple interdigitating bar electrode array or other suitable electrode geometry, preferably comprising a multiple electrode array such as a multiple bar electrode array. The electrode array may also be produced with sawtooth, castellated or other geometry, to maximise or alter the electric field characteristics and/or available surface area for improved particle collection, or to use negative DEP for improved selectivity and abstraction of a specific particle type. The electrode array may be of any functional width or length, with any number of electrode bars separated by an inter-electrode spacing, such that is in keeping with the general aspect of the invention to facilitate a large surface area for efficient DEP collection of particles or cells. Furthermore, the apparatus may include the facility for multiple large surface area electrode arrays, arranged in a parallel or sequential two dimensional arrangement, or stacked in a three dimensional arrangement, or a combination of such two and three dimensional arrangements, to increase the total electrode surface area and improve the efficiency of the initial collection of cells prior to focusing upon the second electrode array.

The second electrode means of the dual electrode arrangement which forms the focusing element of the dual electrode arrangement preferably comprises a twin parallel bar electrode which enables all of the particles released from the first array to be collected and concentrated into a small area for easy detection. As the particles are released from the first electrode array, the velocity profile means that the fluid flow close to the electrode surface is very slow, and the released particles tend to remain close to the base of the chamber until further downstream, enabling efficient focusing of the particles upon the second electrode array. Alternatively, the first electrode array may be re-energised intermittently following the release to avoid any loss of particles into the bulk flow, thus further improving focusing on the second electrode array. This focusing enables an increase in the number of particles per unit volume for purposes of enhanced detection, with the consequence of improving the detection system sensitivity and an improved sensitivity for applications where low particle or cell numbers may have specific impact or clinical significance e.g. disease or infection.

The electrodes are energised at selected frequencies and voltages and other parameters where collection of particular particle types is known to occur very efficiently. Furthermore, more than two different voltages having different predetermined frequencies may be superimposed on and applied to the electrode arrangement in order to attract all the particles in the liquid sample to them. The particles can then be subsequently released en masse by switching off all of the voltages, thus permitting a total particle count to be determined. Alternatively, the particles may be released from the electrodes individually by type by switching off a selected voltage thus facilitating separation of the particles for subsequent collection, identification and/or enumeration and counting of individual components within a mixture (see copending patent application no 0001376.3).

The subsequent enumeration of particles released from the second array is possible using image analysed microscopy detection, fluorescence detection, impedance detection techniques (such as that described in copending patent application no 0001374.8), on-chip particle counting e.g. Coulter counter, optical fibre enhanced spectrophotometric or other technique. This impedance based technique may be used for enumeration of focused particles while the second electrode array is still energised. There is also provided the use of this impedance technique to determine the impedance spectrum of the particles focused on the second electrode array. The complex impedance spectrum measured over the frequency range will be a function of the particle geometry, structure and properties and hence will be characteristic for the particle type. Furthermore, by performing simultaneous measurement of complex impedance and image analysed microscopical counts, an average capacitance/conductance per particle may be obtained which is characteristic for a specific particle type. For samples containing only a single particle type, both of these techniques could thus be used as a rapid identification technique, for these samples of low particle/cell concentration.

The focusing twin bar electrodes can be energised separately from the multiple bar electrode array thus enabling a different frequency or voltage(s) to be applied, thereby improving selectivity. Additionally, selectivity of collection may be made by modification of sample conductivity, or introduction of a medium of different conductivity while the voltage is still applied to cause a differential release of cells, as is often performed by those skilled in the art.

The method may be used for collecting and analysing very low concentrations of different biotic particles such as animal and plant cells, microorganisms and/or different cell types and cell organelles including plasmids. The term micro-organism is intended to embrace bacteria, viruses, yeasts, algae, protozoa, fungi and prions, and any future discovered cellular or noncellular entity of microscopic proportions or macromolecular structure. Abiotic particles which may be separated include for example metal particles or any inorganic or organic material. Chemical or biochemical species can also be separated.

According to a second aspect of the invention there is provided an apparatus for analysing very low concentrations of particles present in a liquid sample, the apparatus comprising a support defining a fluid flow channel through a region of non-uniform electric field density, circulating means for circulating said sample containing said particles through said channel and a dual electrode arrangement for providing the non-uniform electric field, said electrode arrangement comprising a first electrode means connected to which is an AC source for applying at least one voltage at a predetermined frequency and downstream of said first electrode means a second electrode means connected to the same or a different AC source for applying the same or a different voltage(s), wherein the frequency of said voltage(s) is selected to cause a predetermined type of particle to be attracted to said electrode arrangement, and means for determining the quantity of particles when the voltage(s) is not applied.

According to a further aspect of the invention the dimension and shape of the channel may be optimised for height and shape to improve or modify the characteristics of the dielectrophoretic collection. Specifically there is provided the use of a channel narrowing or constriction in the vicinity of the second electrode focusing array. By compressing the particles released from the first electrode array, this further increases the number of particles per unit volume for purposes of enhancing subsequent detection. This narrowing may be a fixed physical constriction produced by the channel wall, or may be a flexible constriction which can be made to narrow when required e.g. triggered by an actuator or valve. Further, the constriction may be a 3-dimensional arrangement to compress the particle stream down from the chamber lid as well as from the chamber side-walls. Alternative methods for compressing the stream of particles released from the first electrode array may equally be employed to increase the focusing of particles upon the second electrode array.

Several such funnel arrangements for creation of narrow particle streams have been described previously. Fiedler et al (1998) described an electrokinetic funnel, whereby an electrical barrier was used to repel cells from the sides of converging electrodes to produce a stream of single cells for electric field cage trapping. Blankenstein & Larsen (1998) used hydrodynamic focusing within microfluidic systems to compress dye solutions into narrow streams, and this has also been demonstrated for particle suspensions. Ultrasonic, optical pressure or travelling wave DEP forces could alternatively be used to focus the stream of particles released from the first electrode array and further improve their concentration upon the second array with subsequently enhanced detection.

According to yet another aspect of the invention there is provided the use of the method defined above or the use of the apparatus defined above for the detection and enumeration of very low concentrations of eukaryotic cells, bacteria, yeasts, viruses, algae, protozoa, fungi, prions, inorganic or organic abiotic particles, plasmids, cell organelles, chemicals or biochemicals including nucleic acids and chromosomes.

A method and apparatus for collecting and analysing very low concentrations of abiotic and/or biotic particles will now be described, by way of example, with reference to the accompanying diagrammatic drawings in which:

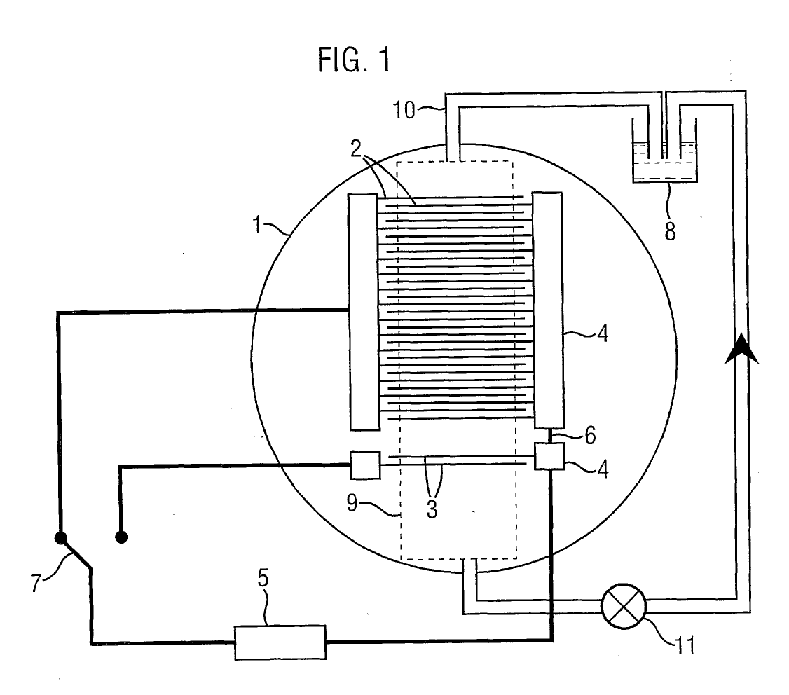

FIG. 1 is a diagram of an electrical and fluid circuit of an apparatus in accordance with the invention;

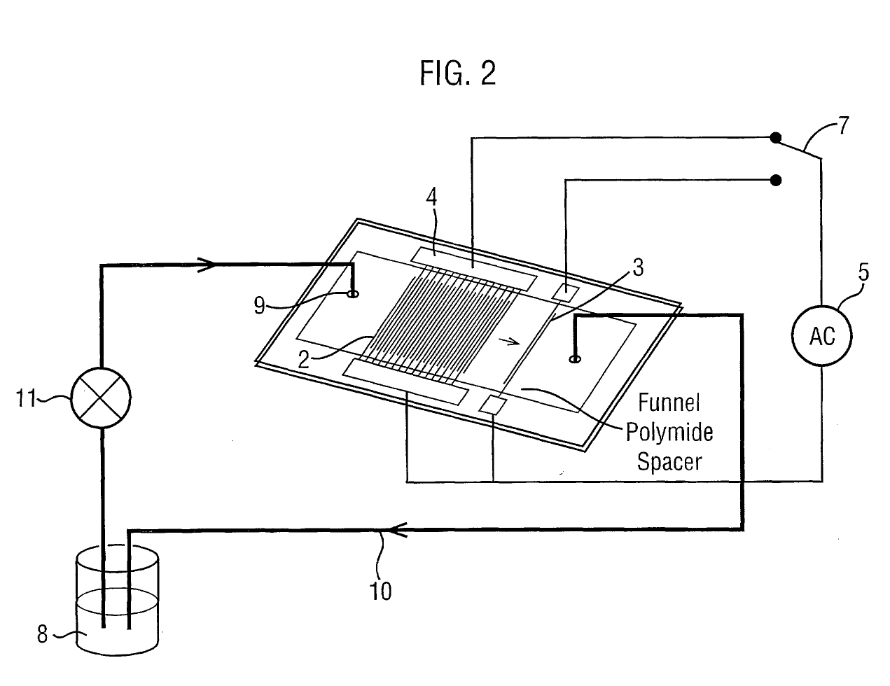

FIG. 2 is a perspective view of an apparatus in accordance with the invention;

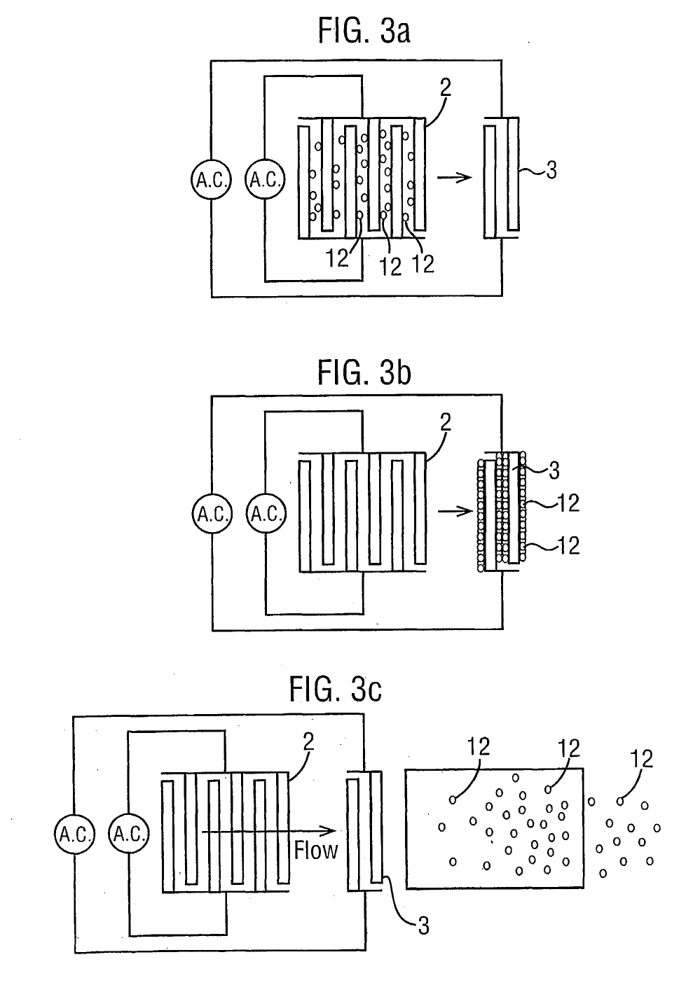

FIGS. 3a, b, c are diagrams of the dual electrode arrangement showing the collection and release of particles during the method in accordance with the invention;

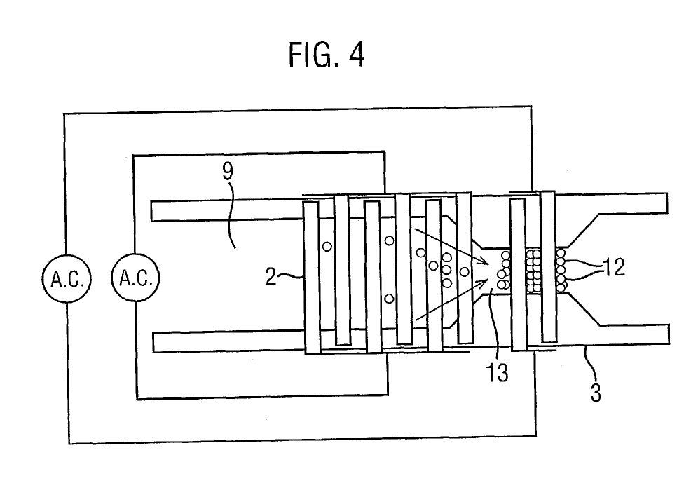

FIG. 4 is a diagram of an alternative embodiment of part of the apparatus in accordance with the invention;

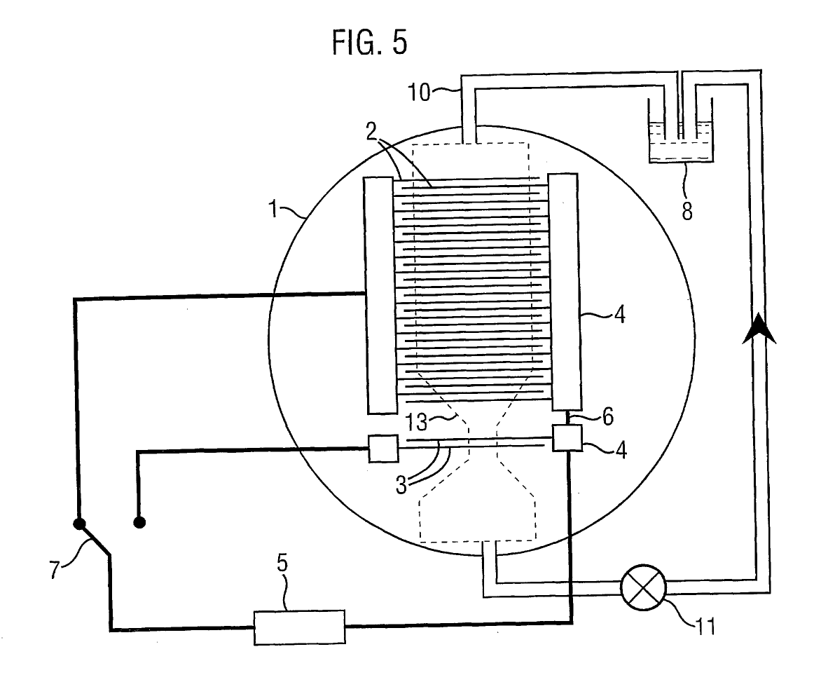

FIG. 5 is a diagram of an electrical and fluid circuit of an apparatus incorporating the embodiment of FIG. 4.

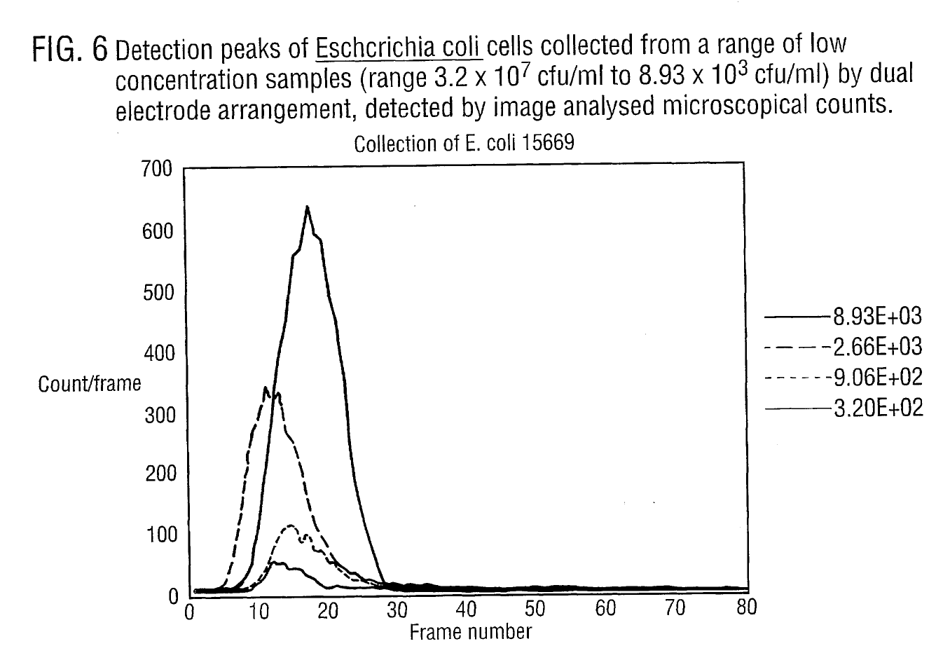

FIG. 6 is a diagram showing detection peaks of Escherichia coli cells collected from a range of low concentration samples by this dual electrode and funnel arrangement, detected by image analysed microscopical counts.

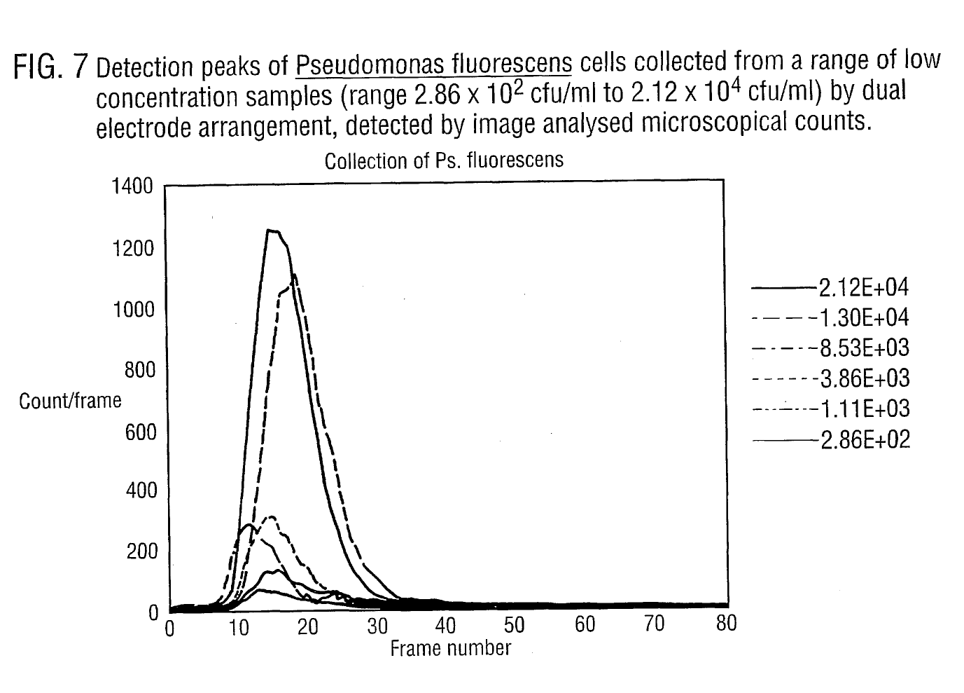

FIG. 7 is a diagram showing detection peaks of Pseudomonas fluorescens cells collected from a range of low concentration samples by this dual electrode and funnel arrangement, detected by image analysed microscopical counts.

The apparatus shown in FIG. 1 comprises a silicon wafer substrate 1 upon which multiple interdigitating parallel electrode bars forming an electrode array 2 have been deposited to form the first electrode means as a large surface area electrode array. Spaced from the large surface area array 2 is the second electrode means which comprises a twin bar electrode 3 which forms the focusing element of the electrode arrangement. Electrode tabs 4 connect the electrode bars 2 and 3 to a signal generator 5 which supplies an AC voltage(s) to the electrodes 2 and 3. Connector 6 joins the electrode tabs 4 of the first array 2 to the twin bar electrode 3. A switch arrangement 7 is provided to facilitate the alternate energising of first electrode array 2 and the twin bar focusing electrode 3.

A reservoir 8 containing the particle suspension under analysis is connected to a fluid flow channel 9, in which the dual electrode arrangement 2 and 3 is positioned, by tubing 10. A pump 11 is provided to move the particle suspension through the tubing 10.

The pump 11 is advantageously a peristaltic pump to prevent any contamination to the sample liquid and particles therein. The fluid in the reservoir 8 may be agitated by bubbling air or other gas therethrough to keep the particles in suspension.

In order to collect a particular particle for enumeration, e.g. E. coli bacteria, the liquid sample is placed in the reservoir 8 and pumped by pump 11 via tubing 10 through the fluid flow channel 9 over electrodes 2 and 3.

The large surface area array 2 is energised with a voltage of a predetermined frequency using signal generator 5 and cells 12 collect on the array 2 as shown in FIG. 3a. At this time the twin bar electrode 3 may be switched on or off. After a suitable period of time has elapsed, the current to the first array 2 is turned off and simultaneously the twin bar electrode 3 is energised. The cells 12 will be released from the first array 2 and will collect in large numbers on the twin bar electrode 3 as shown in FIG. 3b. Since the cells 12 released from the first array 2 will be maintained close to the plane of the electrodes due to the parabolic velocity profile of the flow, the cells 12 will be collected very easily on the twin bar electrode 3 with minimal losses. As the twin bar electrode 3 is energised following the release of cells 12 from the first array 2, the first array 2 may also be re-energised intermittently, to allow cells released from the upstream end of the first array to be maintained close to the electrode surface as they flow downstream to the twin bar electrode 3 to avoid any loos of cells into the bulk liquid.

Once the cells 12 have been collected on the twin bar electrode 3 for a suitable length of time, the current can be turned off thus releasing the cells 12 from the twin bar electrode 3, as shown in FIG. 3c, allowing the cells to be counted by, for example, image analysis microscopy. Alternatively, the complex impedance of the twin bar electrode 3 can be continuously monitored once they have been energised. The focusing of cells upon the twin bar electrode 3 will lead to a change in local conductance and capacitance (as described in copending patent application 0001374.8) and may be used to quantitatively enumerate the cell collection. During this time an impedance spectrum analysis may be performed for identification purposes.

The twin bar electrode 3, or focussing electrode, may be energised separately from the first large surface area array 2 thus pre-selected voltages of different frequency can be employed with a resultant improvement in selectivity.

FIGS. 4 and 5 illustrate an alternative arrangement of the dual electrode and the fluid flow channel. In this embodiment the fluid flow channel 9 narrows at a point 13 in the vicinity of the twin bar electrode 3. The effect of this constriction is that cells released from first array 2, once the current to the array is switched off, are funnelled into a small area where the twin bar electrode 3 is positioned. This arrangement helps to concentrate the cells further, improving the enumeration of them. Alternative methods of channel narrowing or cell funnelling may equally be used as described hereinbefore.

FIGS. 6 and 7 show experimental results obtained using this invention of dual electrode apparatus with channel constriction, illustrated previously in FIGS. 4 and 5. Both figures show peaks produced by the image analysed microscopical detection method of bacterial cells concentrated by this method from several samples, having a range of low cell concentrations. These detection peaks were produced under identical conditions, where collection on the first electrode array at a defined frequency preceded focusing on the second twin electrode array. FIG. 6 shows detection peaks of 4 sample suspensions of E. coli analysed separately, having concentrations in the range 3.2×10² cfu/ml to 8.93×10³ cfu/ml. FIG. 7 shows detection peaks of 6 sample suspensions of Ps, fluorescens, analysed separately, having concentrations in the 2.86×10² cfu/ml to 2.12×10⁴ cfu/ml. Correlations between sample concentration and peak height and area of the detetction peaks have been established for sample concentrations of greater than approx. 10² cfu/ml.

Apart from the image analysis technique referred to above, other methods for enumerating the number of particles released from the twin bar electrode 3 include spectrophotometric (including fluorescence) laser, impedance analysis and radiometric (see copending patent application 0001374.8) or other appropriate technique.

Any number of signal generators may be inductively coupled to apply several different frequencies of voltage to the dual electrode arrangement. By using an appropriate number of frequencies, it may be possible to collect every type of particle in a suspension. By changing the applied frequencies or voltage(s) different particle types can be released individually for subsequent enumeration.

### REFERENCES

Anon. (1989) The Water Supply (Water Quality) Regulations 1989 (Statutory Instrument No 1147) (as amended by SI No 1384 (1989), SI No 1837 (1991) and SI No 2790 (1991). London. HMSO.

Archer G. P., Betts W. B. & Haigh T. (1993) Rapid differentiation of untreated and treated Cryptosporidium parvum oocysts using dielectrophoresis. Microbios 73, 165-172.

Archer G. P., Quinn C. M., Betts W. B., Allsopp D. W. E. & O'Neill J. G. (1995) Physical separation of untreated and ozone treated Cryptosporidium parvum oocysts using non-uniform electric fields. In Protozoan Parasites and Water. (Eds.) Betts W. B., Casemore D., Fricker C., Smith H. V & Watkins J., pp. 143-145. The Royal Society of Chemistry, Cambridge.

Becker F. F., Wang X-B, Huang Y., Pethig R., Vykoukal J. & Gascoyne P. R. C. (1994) The removal of human leukaemia cells from blood using interdigitated microelectrodes. J. Phys. D: Appl. Phys. 27, 2659-2662.

Betts W. B. (1995) The potential of dielectrophoresis for the real-time detection of micro-organisms in foods. Trends Food Sci. Technol. 6, 51-58.

Blankenstein G. & Larsen U. D. (1998) Modular concept of a laboratory on a chip for chemical and biochemical analysis. Biosensors and Bioelectronics, 13, 427-438.

Brown A. P., Betts W. B., Harrison A. B. & O'Neill J. G. (1999) Evaluation of a dielectrophoretic bacterial counting technique. Biosensors & Bioelectronics 14, 341-351.

Burt J. P. H., Pethig R., Gascoyne P. R. C. & Becker F. F. (1990) Dielectrophoretic characterisation of Friend murine erythroleukaemic cells as a measure of induced differentiation. Biochim. Biophys. Acta 1034, 93-101.

Cheng J., Sheldon E. L., Wu L., Uribe A., Gerrue L. O., Carrino J., Heller M. J. & O'Connell J. P. O. (1998) Preparation and hybridization analysis of DNA/RNA from E. coli on microfabricated bioelectronic chips. Nature Biotechnology, 16, 541-546.

Crane J. S. & Pohl H. A. (1968) A study of living and dead yeast cells using dielectrophoresis. J. Electrochem. Soc. 115, 584-586.

Crane J. S. & Pohl H. A. (1977) Use of the balanced cell technique to determine properties of single yeast cells. Journal of Biological Physics. 5, 49-74.

Fiedler S., Shirley S. G., Schnelle T. & Fuhr G. (1998) Dielectrophoretic sorting of particles and cells in a microsystem. Analytical Chemistry, 70, 1909-1915.

Fuhr G. & Reichle C. (2000) Living cells in opto-electrical cages. Trends Anal. Chem. 19, 402-409.

Fuhr G., Schnelle T., Muller T., Hitzler H., Monajembashi S. & Greulich K. O. (1998) Force measurements of optical tweezers in electro-optical cages. J. Appl. Phys. A 67, 385-390.

Gascoyne P. R. C., Huang Y., Pethig R., Vykoukal J. &Becker F. F. (1992) Dielectrophoretic separation of mammalian-cells studied by computerized image-analysis. Meas. Sci. Technol. 3, 439-445.

Gascoyne P. R. C., Noshari J., Becker F. F. & Pethig R. (1994) Use of dielectrophoretic collection spectra for characterizing differences between normal and cancerous cells. IEEE Trans. Ind. Appl. 30, 829-834.

Goater A. D., Burt J. P. H. & Pethig R. (1997) A combined travelling wave dielectrophoresis and electrorotation device: applied to the concentration and viability determination of Cryptosporidium. J. Phys. D: Appl. Phys. 30, L65-L69.

Hagedorn R., Fuhr G., Muller T. & Gimsa J. (1992) Travelling-wave dielectrophoresis of microparticles. Electrophoresis 13, 49-54.

Huang Y., Holzel R., Pethig R. & Wang X-B. (1992) Differences in the AC electrodynamics of viable and nonviable yeast-cells determined through combined dielectrophoresis and electrorotation studies. Phys. Med. Biol. 37, 1499-1517.

Huang Y., Wang X-B., Tame J. A. & Pethig R. (1993) Electrokinetic behaviour of colloidal particles in travelling electric-fields—studies using yeast-cells. J. Phys. D-Appl. Phys. 26, 1528-1535

Kaler K. V. I. S. & Jones T. B. (1990) Dielectrophoretic spectra of single cells determined by feedback-controlled levitation. Biophysical Journal. 57, 173-182.

Leiby D. A, Kerr K. L., Campos J. M. & Dodd R. Y. (1997) A retrospective analysis of microbial contaminants in outdated random-donor platelets from multiple sites. Transfusion, 37, 259-263.

Markx G. H., Dyda P. A. & Pethig R. (1996) Dielectrophoretic separation of bacteria using a conductivity gradient. J. Biotechnol. 51, 175-180.

Markx G. H., Huang Y., Zhou X-F. & Pethig R. (1994) Dielectrophoretic characterisation and separation of micro-organisms. Microbiology 140, 585-591.

Markx G. H., Pethig R. & Rousselet J. (1997) The dielectrophoretic levitation of latex beads, with reference to field-flow fractionation. J. Phys. D: Appl. Phys. 30, 2470-2477.

Muder R. R, Yee Y. C., Rihs J. D. & Bunker M. (1992) Staphylococcus epidermis bacteremia from transfusion of contaminated platelets: application of bacterial DNA analysis. Transfusion, 32, 771-774.

Pethig R (1991) Application of AC electrical fields to the manipulation and characterisation of cells. In Automation in Biotechnology. (Ed.) Karube I., pp. 159-185. Elsevier, Amsterdam.

Pethig R., Huang Y., Wang X-B. & Burt J. P. H. (1992) Positive and negative dielectrophoretic collection of colloidal particles using interdigitated castellated electrodes. J. Phys. D: Appl. Phys. 24, 881-888.

Pohl H. A. (1978) Dielectrophoresis. Cambridge University Press, Cambridge.

Pohl H. A. & Crane J. S. (1971) Dielectrophoresis of cells. Biophys. J. 11, 711-727.

Pohl H. A. & Hawk I. (1966) Separation of living and dead cells by dielectrophoresis. Science 152, 647-649.

Quinn C. M., Archer G. P., Betts W. B. & O'Neill J. G. (1996) Dose-dependent dielectrophoretic response of Cryptosporidium oocysts treated with ozone. Lett. Appl. Microbiol. 22,224-228.

Quinn C. M., Archer G. P., Betts W. B. & O'Neill J. G. (1995) An image analysis enhanced dielectrophoretic analysis of chlorine and ozone treated Cryptosporidium parvum oocysts. In Protozoan Parasites and Water. (Eds.) Betts W. B., Casemore D., Fricker C., Smith H. V. & Watkins J., pp. 125-132. The Royal Society of Chemistry, Cambridge.

Schnelle T., Muller T., Reichle C. & Fuhr G. (2000) Combined dielectrophoretic field cages and laser tweezers for electrorotation. Appl. Phys. B 70, 267-274.

Washizu M. & Kurosawa O. (1990) Electrostatic manipulation of DNA in microfabricated structures. IEEE Transactions on Industry Applications, 26, 1165-1171.

WO 91108284 Betts W. B., Hawkes J. J. Dielectrophoretic characterisation of microorganisms and other particles

WO 91/11262 Pethig R., Burt J. P. H. Manipulation of solid, semi-solid or liquid materials.

GB 2,266,153 Betts W. B., Hawkes J. J. Dielectrophoretic separating of a mixture of particles.

Betts, W. B., Milner, K. R. & Brown, A. P. (2000) impedance Measurement. British Patent Application No. 0001374.8 [22:01:2000].

1. A method of analysing very low concentrations of particles present in a fluid sample, the method comprising passing or circulating the liquid or gaseous sample through a region of non-uniform electric field density produced by a dual electrode arrangement, said arrangement comprising a first electrode means for producing successive electric fields so as to collect all or most of the particles in the sample and a second electrode means to collect all the particles released from the first electrode means for detection, energising said first electrode means with at least one AC voltage having a predetermined frequency(s) selected to attract a predetermined type of particle(s) in the sample to said array, switching off the voltage to the first electrode thereby releasing the particles, energising the second electrode means with at least one AC voltage(s) having a predetermined frequency(s) selected to attract particles in the sample to said second electrode means, switching off the voltage(s) to the second electrode means thereby releasing the particles for subsequent separation, collection, identification and/or enumeration.

2. The method according to claim 1, wherein the first electrode means is a large surface area multiple bar electrode and the second electrode means is a twin bar electrode.

3. An apparatus for analysing very low concentrations of particles present in a fluid sample, the apparatus comprising a support defining a fluid flow channel through a region of non-uniform electric field density, circulating means for circulating said sample containing said particles through said channel and a dual electrode arrangement for providing the non-uniform field, said electrode arrangement comprising a first electrode means connected to which is an AC source for applying at least one voltage at a predetermined frequency(s) and downstream of said first electrode means a second electrode means connected to the same or a different AC source for applying the same or a different voltage(s), wherein the frequency(s) of said voltage is selected to cause a predetermined type of particle to be attracted to said electrode arrangement, and means for determining the quantity of particles when the voltage(s) is not applied.

4. The apparatus according to claim 3, wherein the first electrode means is a large surface area multiple bar electrode and the second electrode means is a twin bar electrode.

5. The apparatus according to claim 3, wherein the first electrode means is a set of several large surface area multiple bar electrodes arranged in parallel or series in a 2-dimension or 3-dimension arrangement for increased collection efficiency, and the second electrode means is a twin bar electrode.

6. The apparatus according to claim 3, claim 4 or claim 5, incorporating a channel restriction or narrowing, either fixed or moveable, to further focus or concentrate cells or particles upon the first or second electrode array for enhanced concentration, detection, enumeration and/or identification

7. Use of the method according to claim 1 or claim 2, or of the apparatus according to claim 3, claim 4, claim 5 or claim 6 for the detection and enumeration of very low concentrations of eukaryotic cells, bacteria, yeasts, viruses, algae, protozoa, fungi, prions, inorganic or organic abiotic particles, plasmids, cell organelles, chromosomes, chemicals or biochemicals including nucleic acids and proteins.

8. The method of analysing very low concentrations of particles present in a liquid or gaseous sample substantially as hereinbefore described.

9. Apparatus for analysing very low concentrations of particles present in a liquid sample substantially as hereinbefore described with reference to the accompanying drawings.
